(19) United States
(12) Patent Application Publication
(10) Pub. No.: US 2013/0269158 A1
(43) Pub. Date: Oct. 17, 2013

(54) POSITIONING POLE AND A POSITIONING SYSTEM AND A METHOD OF POSITIONING A POLE TO A COVERING

(71) Applicant: Chao Chun Yeh, HSINCHU (TW)

(72) Inventor: Chao Chun Yeh, HSINCHU (TW)

(73) Assignee: MICROELECTRONICS TECHNOLOGY, INC., HSINCHU (TW)

(21) Appl. No.: 13/445,240

(22) Filed: Apr. 12, 2012

(51) Int. Cl. F16B 1/00; B23P 11/00

(52) U.S. Cl. 24/595.1; 29/428

(57) ABSTRACT

A positioning pole includes a pole body, and at least three protruding ribs. The three protruding ribs are disposed around a circumference of the pole body. An axis of one of the protruding ribs is parallel to an axis of the pole body. The pole body has a terminal surface. The protruding ribs have top surfaces. The top surfaces and the terminal surface are disposed on the same horizontal level.

### BACKGROUND OF THE INVENTION

(A) Field of the Invention

The present invention relates to a positioning pole, a positioning system, and a method of positioning a pole to a covering; and more particularly, to a positioning system, and a method of positioning a pole to a covering for alignment.

(B) Description of the Related Art

FIG. 1 is a schematic view of a positioning system 10. The positioning system 10 comprises a base 11, a covering 12, and two positioning pole 13. The covering 12 includes two holes 121, while the base 11 includes two apertures (not shown) for accommodating the positioning pole 13. Since the holes 121 might not align with the apertures due to systematic error, the covering 12 and the base 11 cannot perfectly align with each other when the positioning pole 13 is placed in the hole 121 and the aperture.

In view of the above, the conventional positioning system 10 has several disadvantages for alignment. A development for a better positioning system will resolve the aforesaid problem.

### SUMMARY OF THE INVENTION

The present invention provides a positioning pole. The positioning pole includes a pole body and at least three protruding ribs. The three protruding ribs are disposed around a circumference of the pole body.

The present invention discloses a method of positioning a positioning pole to a covering. The method of positioning a positioning pole comprises the steps of: providing a covering; forming a hole through the covering, thereby exposing a circumference of the hole; drilling at least one aperture around the circumference of the hole; and disposing the positioning pole in the hole.

The present invention also discloses a positioning system. The positioning system includes a base, a covering, and a positioning pole. The covering includes a covering body and a hole, which is formed in the covering body through the covering body. The covering body is disposed on the base. The positioning pole includes a pole body and at least three protruding ribs. The three protruding ribs are disposed around a circumference of the pole body. The positioning pole is disposed in the hole to align the base and the covering.

The foregoing has outlined rather broadly the features and technical benefits of the disclosure in order that the detailed description of the invention that follows may be better understood. Additional features and benefits of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the disclosure. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon reference to the accompanying drawings in which:

FIG. 1 is a perspective view of a traditional positioning system;

FIG. 2 is a perspective view of a positioning system in accordance with one embodiment of the present invention;

FIG. 3 is a flow chart of a method of positioning a positioning pole to a covering in accordance with one embodiment of the present invention;

FIG. 4 is a perspective view of a positioning pole in accordance with one embodiment of the present invention;

FIG. 5 is a top view of a positioning pole in accordance with one embodiment of the present invention in FIG. 3;

FIG. 6 is a top view of a positioning pole in accordance with another embodiment of the present invention;

FIG. 7 is a perspective view of a positioning system in accordance with another embodiment of the present invention; and

FIG. 8 is an enlarged view of a positioning pole in a hole shown in FIG. 7.

### DETAILED DESCRIPTION OF THE INVENTION

In the following description, numerous specific details are set forth. However, it should be understood that embodiments of the disclosure may be practiced without these specific details. In other instances, well-known methods, structures and techniques have not been shown in detail in order not to obscure an understanding of this description. References to “one embodiment,” “an embodiment,” “another embodiment,” “other embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present invention is directed to a positioning pole and a positioning system and a method of positioning a pole to a covering. In order to make the present invention completely comprehensible, detailed steps and structures are provided in the following description. Obviously, implementation of the present invention does not limit special details known by persons skilled in the art. In addition, known structures and steps are not described in detail, so as not to limit the present invention unnecessarily. Preferred embodiments of the present invention will be described below in detail. However, in addition to the detailed description, the present invention may also be widely implemented in other embodiments. The scope of the present invention is not limited to the detailed description, and is defined by the claims.

The following descriptions illustrate a positioning pole and a positioning system and a method of positioning a pole to a covering. Regarding the schematic diagrams disclosed by embodiments, the present invention is only illustrated by diagrams, but the scope of the present invention is not limited by the diagrams. These schematic diagrams show the structure of the apparatus, while the dimensions of the diagrams cannot limit the scope of the present invention. The aforesaid statements are intended to provide further understanding before the following embodiments are introduced.

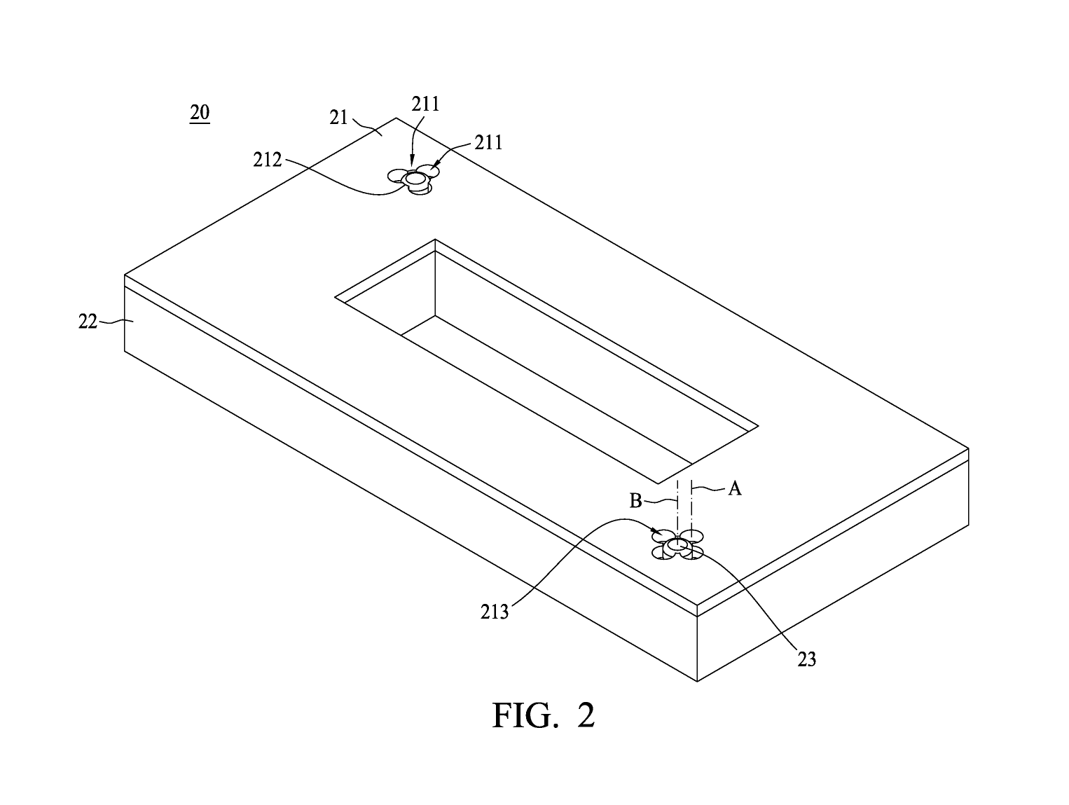

FIG. 2 shows a perspective view of a positioning system 20 of the present invention. In the embodiment, the positioning system 20 includes a covering 21, a base 22, and at least one positioning pole 23. In the embodiment, the positioning system 20 includes, but is not limited to, two positioning poles 23; in other embodiments (not shown), the positioning system 20 can be performed or implemented by a single positioning pole 23.

The covering 21 shown in FIG. 2 can be manufactured by a method including the following steps. Since a hole 211 is formed through the covering 21, a circumference 212 of the hole 211 is exposed. Next, at least one aperture 213 is drilled around the circumference 212 of the hole 211. In the embodiment shown in FIG. 2, the hole 211 (left-hand portion of the covering 21) includes three apertures 213, while the hole 211 (right-hand portion of the covering 21) filled by the positioning pole 23 includes four apertures 213. In the embodiment, these apertures 213 might not be limited to penetrate through the covering 21. Thus, these apertures 213 can be formed as grooves in the covering 21.

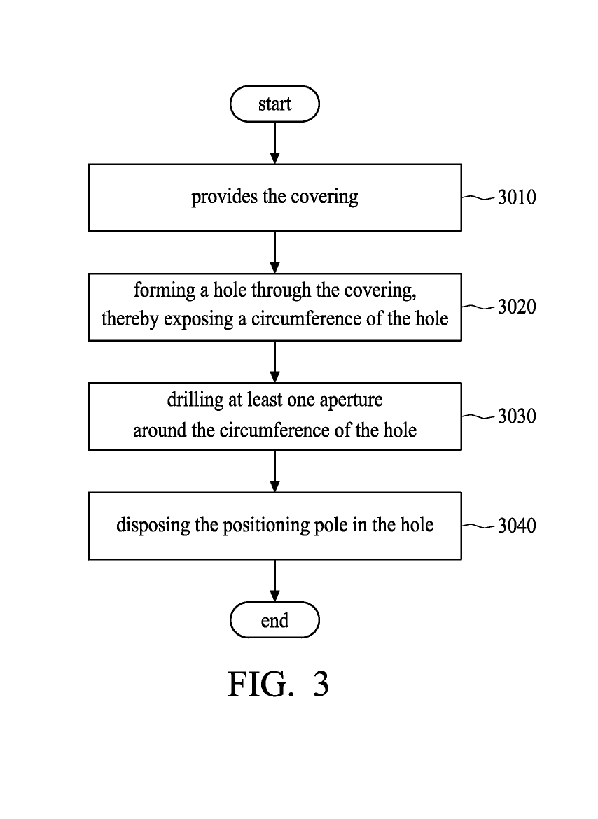

In the embodiment shown in FIG. 2, the positioning system 20 can be accomplished by a method of positioning a positioning pole 23 to a covering 21, as shown in FIG. 3. The method comprises the following steps: Step 3010 provides the covering 21 and then Step 3020 is implemented. Step 3020 forms a hole 211 through the covering 21, thereby exposing a circumference 212 of the hole 211, and then Step 3030 is implemented. In Step 3030, at least one aperture around the circumference 212 of the hole 211 is drilled and then Step 3040 is implemented. Step 3040 disposes the positioning pole 23 in the hole 211. Since the design of the hole 211 and the apertures 213 provides the capability of adjusting the deviation between the covering 21 and the base 22, the covering 21 and the base 22 can be perfectly aligned by utilizing general positioning poles 23. In the embodiment, a printed circuit board (not shown) can be disposed between the covering 21 and the base 22. The positioning pole 23 will penetrate the hole 211, the printed circuit board, and the base 22, which includes at least one groove (not shown) opposite to the hole 211 for accommodating the positioning pole 12.

In the embodiment shown in FIG. 2, at least one of the apertures 213 may be, but is not limited to, penetrating the covering 21. Thus, the aperture 213 can be designed either to penetrate the covering 21 or not. In the embodiment, an axis A of the aperture 213 may be, but is not limited to, parallel to an axis B of the hole 211. In the embodiment, the distance between the center of the hole 211 and the center of the aperture 213 is less than the radius of the aperture 213 plus the radius of the hole 211. However, in another embodiment (not shown), the distance between the center of the hole 211 and the center of the aperture 213 is equal to the radius of the aperture 213 plus the radius of the hole 211. In other words, the aperture 213 connects with the hole 211 in a tangency of the hole 211.

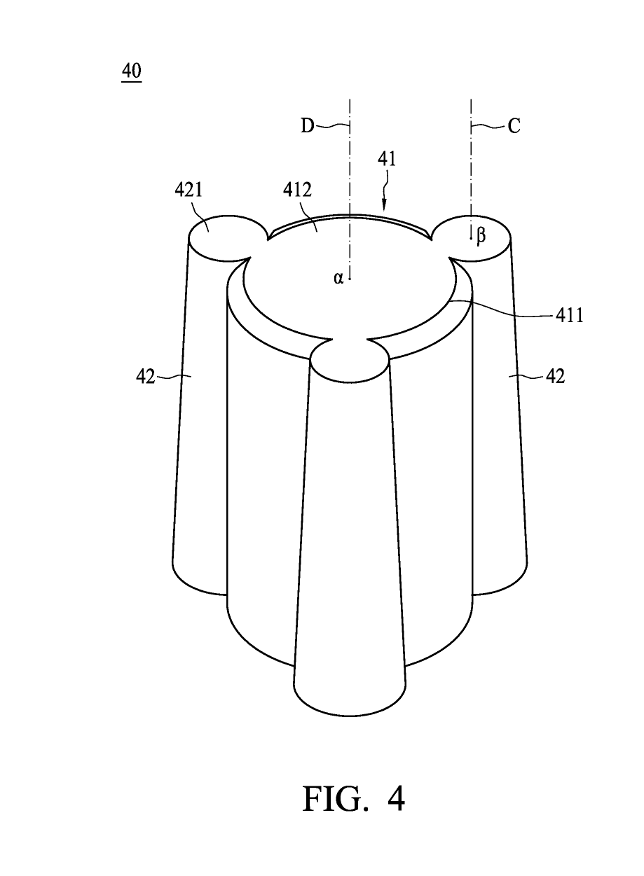

The present invention also discloses a positioning pole 40 shown in FIG. 4. The positioning pole 40 comprises a pole body 41 and at least three protruding ribs 42, which are disposed around a circumference 411 of the pole body 41. In the embodiment, an axis C of one of the protruding ribs 42 is parallel to an axis D of the pole body 41. In other words, the protruding ribs 42 are parallel to the pole body 41. However, in another embodiment (not shown) the protruding ribs 42 can be spirally disposed around the circumference 411 of the pole body 41, which means that the axis of one of the protruding ribs 42 is not parallel to the axis of the pole body 41.

In the embodiment shown in FIG. 4, the axis of each of the protruding ribs 42 is parallel to the axis D of the pole body 41. In the embodiment, the distance between the center a of the pole body 41 and the center f3 of the protruding ribs 42 is less than the radius of the pole body 41 plus the radius of the protruding rib 42. However, in another embodiment (not shown), the distance between the center a of the pole body 41 and the center f3 of the protruding ribs 42 is equal to the radius of the pole body 41 plus the radius of the protruding ribs 42. In other words, one of the protruding ribs 42 connects with the pole body 41 in a tangency of the pole body 41. In addition, the pole body 41 has a terminal surface 412, while one of the protruding ribs 42 has a top surface 421. In the embodiment shown in FIG. 4, the top surfaces 421 of all the protruding ribs 42 and the terminal surface 412 are disposed at the same horizontal level. However, in another embodiment (not shown), certain top surfaces 421 of the protruding ribs 42 might be lower or higher than the terminal surface 412. In other words, certain top surfaces 421 of the protruding ribs 42 and the terminal surface 412 are not disposed at the same horizontal level. In addition, the protruding rib 42 has a cone shape. In other words, the area of the top surface 421 of the protruding rib 42 is smaller the bottom surface of the protruding rib 42. By such design, the positioning pole 40 with such protruding ribs 42 can be disposed into the hole (not shown) and perfectly align the covering (not shown) and the base (not shown).

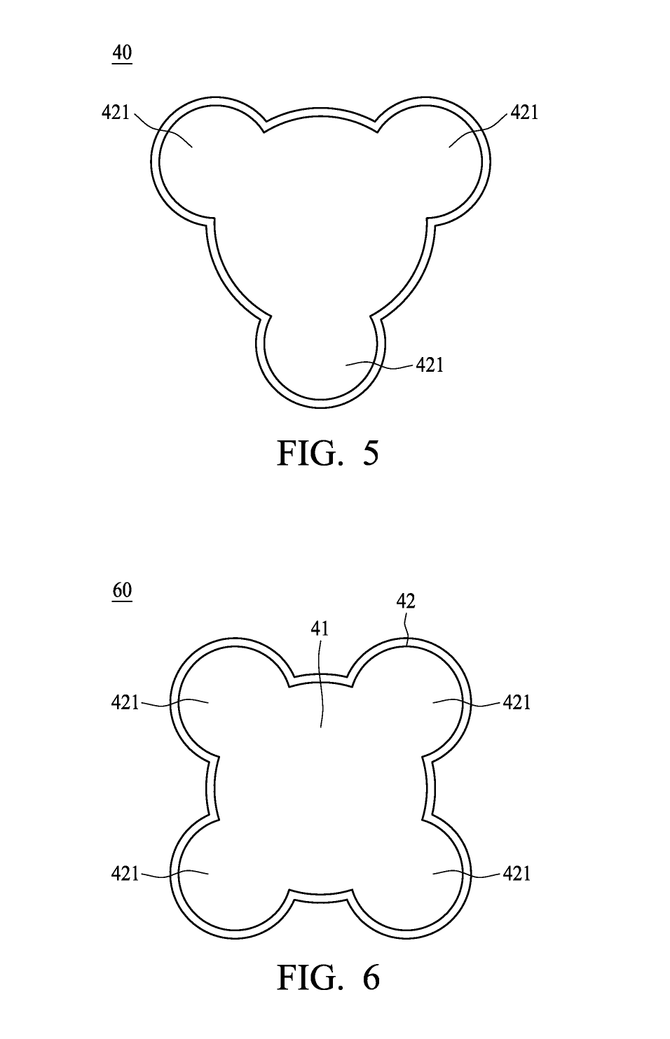

In the embodiments shown in FIG. 5, the top view of the positioning pole 40 includes three top surfaces 421. In another embodiment shown in FIG. 6, the top view of the positioning pole 60 includes four top surfaces 421. In other words, the positioning pole 60 includes four protruding ribs 42, which connect with the pole body 41.

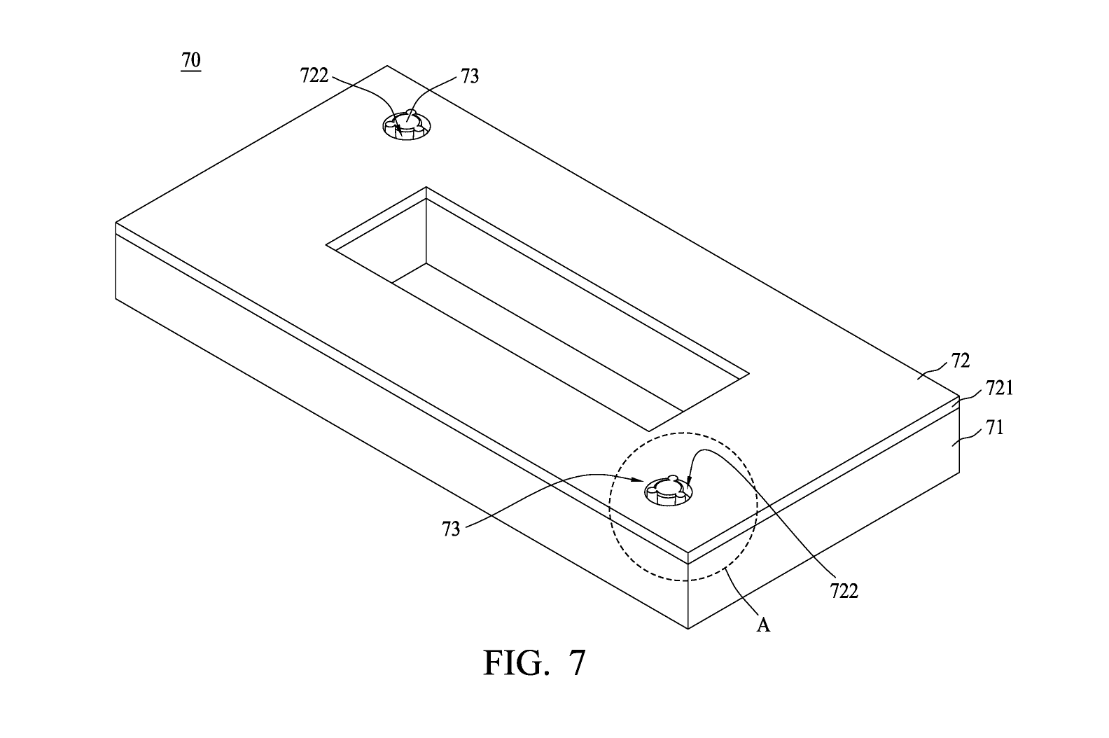

In the embodiment shown in FIG. 7, the positioning system 70 includes a base 71, a covering 72, and two positioning poles 73. In another embodiment (not shown), a single positioning pole 73 can be designed to have function equivalent to that of the positioning system 70 with two positioning poles 73. The covering 72 includes a covering body 721 and two holes 722 in the embodiment shown in FIG. 7; however, in other embodiments (not shown), the covering 72 may include a single hole 722 to accommodate the positioning pole 73. In the embodiment, the hole 722 is formed in the covering body 721 through the covering body 721, which is disposed on the base 71.

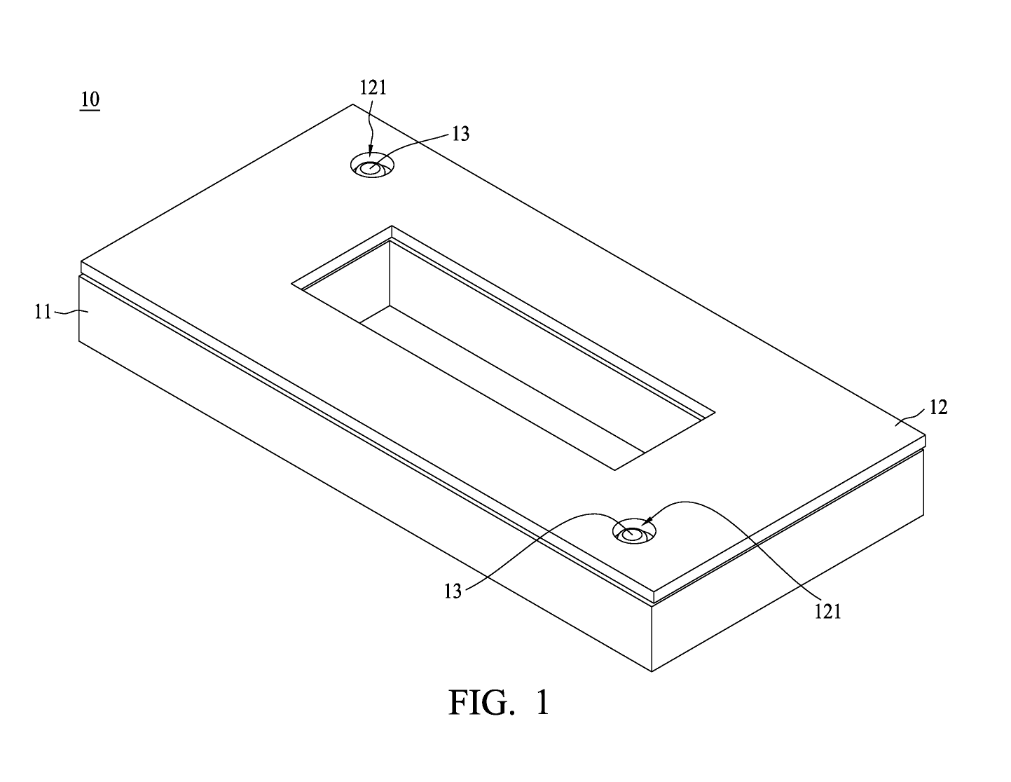

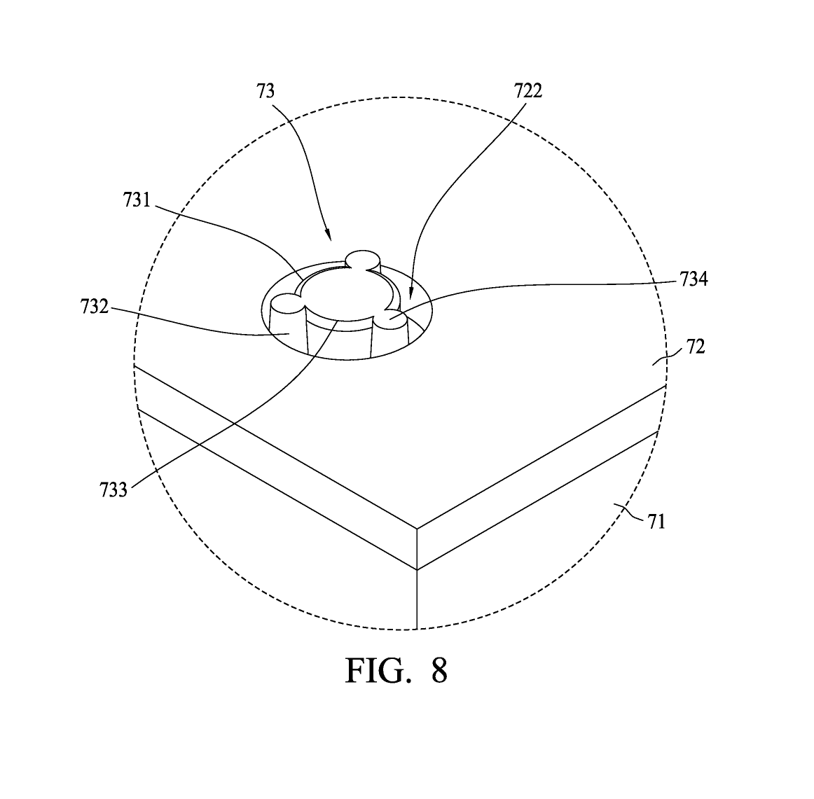

FIG. 8 shows the enlarged view of a positioning pole 73 in a hole 722, which is an enlarged version of the circle A of FIG. 7. As shown in FIG. 8, the positioning pole 73 includes a pole body 731 and at least three protruding ribs 732. The three protruding ribs 732 are disposed around a circumference 733 of the pole body 731. In addition, the positioning pole 73 is similar to the positioning pole 40 shown in FIG. 4. Since the positioning pole 73 is disposed in the hole 722, the protruding ribs 732 can be deformed to perfectly align the base 71 and the covering 72. In other words, the positioning pole 73 is capable of aligning the base 71 and the covering 72. Such function cannot be achieved by the traditional positioning pole 13, as shown in FIG. 1. In addition, the protruding rib 732 has a cone shape. In other words, the area of the top surface 734 of the protruding rib 732 is smaller the bottom surface of the protruding rib 732. By such design, the positioning pole 73 with such protruding ribs 732 can be disposed into the hole 722 and perfectly align the covering 72 and the base 71.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A positioning pole comprising:
a pole body; and
at least three protruding ribs, disposed around a circumference of the pole body.

2. The positioning pole of claim 1, wherein an axis of one of the protruding ribs is parallel to an axis of the pole body.

3. The positioning pole of claim 1, wherein the axis of each of the protruding ribs is parallel to an axis of the pole body.

4. The positioning pole of claim 1, wherein one of the protruding ribs connects with the pole body in a tangency of the pole body.

5. The positioning pole of claim 1, wherein the pole body has a terminal surface, one of the protruding ribs has a top surface, and the top surface and the terminal surface are disposed on the same horizontal level.

6. The positioning pole of claim 1, wherein the pole body has a terminal surface, the protruding ribs have top surfaces, and the top surfaces and the terminal surface are disposed on the same horizontal level.

7. The positioning pole of claim 1, wherein protruding rib has a cone shape.

8. A method of positioning a positioning pole to a covering, the method comprising the steps of:
providing the covering;
forming a hole through the covering, thereby exposing a circumference of the hole;
drilling at least one aperture around the circumference of the hole; and
disposing the positioning pole in the hole.

9. The method of claim 8, wherein at least one of the apertures penetrates the covering.

10. The method of claim 8, wherein an axis of the aperture is parallel to an axis of the hole.

11. The method of claim 8, wherein the aperture connects with the hole in a tangency of the hole.

12. A positioning system, comprising:
a base;
a covering, including a covering body and a hole, wherein the hole is formed in the covering body through the covering body, and the covering body is disposed on the base; and
a positioning pole, including a pole body and at least three protruding ribs, disposed around a circumference of the pole body, wherein the positioning pole is disposed in the hole to align the base and the covering.

13. The positioning system of claim 12, wherein an axis of one of the protruding ribs is parallel to an axis of the pole body.

14. The positioning system of claim 12, wherein the axis of each of the protruding ribs is parallel to an axis of the pole body.

15. The positioning system of claim 12, wherein one of the protruding ribs connects with the pole body in a tangency of the pole body.

16. The positioning system of claim 12, wherein the pole body has a terminal surface, one of the protruding ribs has a top surface, and the top surface and the terminal surface are disposed on the same horizontal level.

17. The positioning system of claim 12, wherein the pole body has a terminal surface, the protruding ribs have top surfaces, and the top surfaces and the terminal surface are disposed on the same horizontal level.

18. The positioning system of claim 12, wherein protruding rib has a cone shape.
